(19) United States
(12) Patent Application Publication
(10) Pub. No.: US 2001/0023903 A1
(43) Pub. Date: Sep. 27, 2001

(54) Process for recycling material containing high-tenacity fibers impregnated with a resin matrix

(76) Inventor: Hans E. Korte, Wismar (DE)

Correspondence Address: OLIFF & BERRIDGE, PLC, 277 S. WASHINGTON STREET, SUITE 500, ALEXANDRIA, VA, 22314, US

(21) Appl. No.: 09/800,734

(22) Filed: Mar. 8, 2001

(30) Foreign Application Priority Data
Mar. 8, 2000 (EP) 00104 949.3

(51) Int. Cl. B02C 19/12

(52) U.S. Cl. 241/24.18; 241/24.19

(57) ABSTRACT

A process for recycling a material containing high-tenacity fibers impregnated with a resin matrix includes introducing the material containing the high-tenacity fibers and the resin matrix into a hammer mill having a shaft mounted with at least three series or stages of hammers and a substantially cylindrical sieve disposed substantially concentrically around the shaft, milling the material for a time sufficient to grind at least about 50%, and preferably at least about 80%, of the resin into small particles, and separating the small resin particles from the fibers by means of the sieve. This process allows a very high degree of separation and does not require additional process steps like cryogenical chilling.

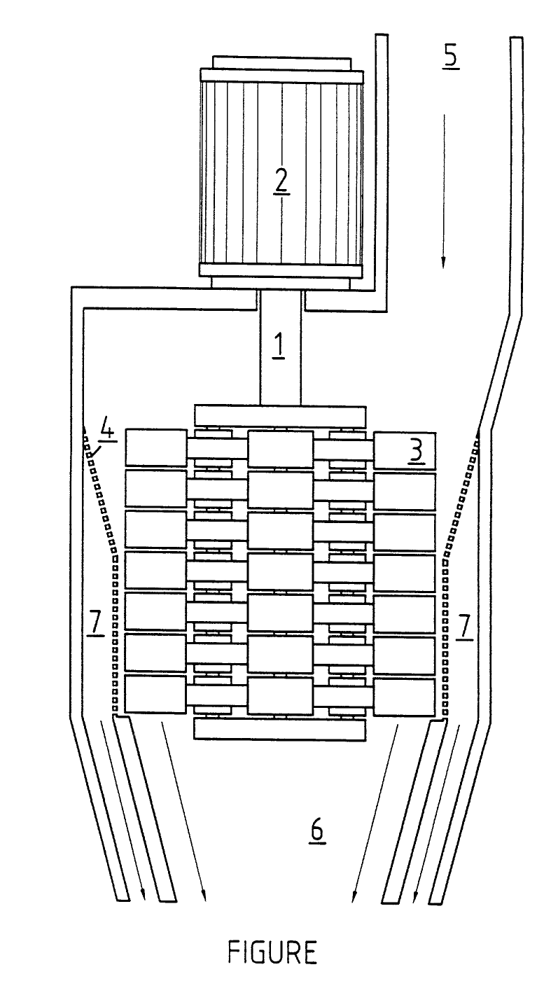

### BACKGROUND OF THE INVENTION

1. Field of the Invention

The invention pertains to a process for recycling material containing high-tenacity fibers impregnated with a resin matrix.

2. Description of Related Art

Such a process is known from, e.g., EP 324 910 A2, which describes how pieces of aramid cloth impregnated with a blend of phenolic and polyvinyl butyral resins are cryogenically chilled to a point of embrittlement in a liquid nitrogen bath and then fed to a rotary impact mill (which is chilled by cold gaseous nitrogen from the nitrogen bath) to comminute the pieces into a composite material suitable for use in brake linings and the like. The use of liquid nitrogen renders the process expensive, complicated, and hazardous.

Moreover, it is preferred not to grind the composite material into smaller pieces of composite material, but, instead, to actually separate the high tenacity aramid fibers from the resin matrix. For, the resin residues still present in the fibrous material renders the fibers unsuitable for use in applications such as gaskets, paper, or stretch broken yarn and may react when used in a friction composite.

### SUMMARY OF THE INVENTION

It is the object of this invention to provide a process for recycling products comprising high-tenacity fibers embedded in a resin matrix which is inexpensive and allows a high degree of separation.

This object is achieved by a process comprising introducing a material containing fibers and a resin matrix into a hammer mill, which comprises a shaft mounted with at least three series or stages of hammers and a substantially cylindrical sieve disposed substantially concentrically around the shaft, milling the material for a time sufficient to grind at least about 50%, and preferably at least about 80%, of the resin into small particles (without substantially grinding the high-tenacity fibers and/or the fabric into small particles), and separating the small resin particles from the fibers using the sieve.

### DETAILED DESCRIPTION OF PREFERRED EMBODIMENTS

Hammer mills, such as the Markseparator Centurion ex Pallmann, are known for processing vegetable materials like sugar-cane, which consist of a soft marrow or medulla surrounded by a tough wall of cellulose fibers. Surprisingly, it was found that the hammer mill, which is designed to separate a soft substance (i.e., the medulla) from a shell of natural fibers, is eminently suitable for separating high-tenacity synthetic fibers, for instance aramid fibers, from the brittle or friable resin matrix with which they are impregnated. As described below, the process according to the invention allows a very high degree of separation. Further, in the invention, there is no need for expensive and hazardous process steps like cryogenical chilling.

A hammer mill especially suitable for use in the processes according to this invention is depicted in the Figure. The mill comprises a shaft 1 driven by an electric motor 2 and mounted with seven series or stages of four hammers 3 each and a cylindrical sieve 4 disposed concentrically around the shaft 1. A top part of the sieve 4 is upwardly divergent (as the frustum of a cone) so as to locally increase the distance between the hammers 3 nearest an inlet 5 and the sieve 4. Thus, larger pieces introduced into the mill are effectively reduced in size before reaching the lower hammers, and the risk of jamming is minimized.

A suitable alternative to the diverging sieve 4 is the use of shorter helves to mount the hammers in the upper stages on the main shaft 1.

According to the invention, it is preferred that the shaft and the sieve are disposed substantially vertically because this allows for continuous feeding of the material which is to be recycled to the inlet 5 and, of course, also for continuous removal of the fibrous particles from a first outlet 6 and of the resin particles from a second (annular) outlet 7.

Alternatively, the hammers may have a propeller-like shape, which causes an airflow forcing the materials through the device. This technique may, of course, also be used in combination with a vertical shaft and sieve, in which case it serves to increase the flow rate of the materials.

To further reduce the risk of jamming, at least the hammers nearest the inlet of the hammer mill are pivotably and resiliently mounted on the shaft, thus enabling the hammer to let larger chunks pass. However, it is preferred that all the hammers of the hammer mill are pivotably and resiliently mounted on the shaft.

According to the invention, it has been found that the degree of separation and the particle size and particle size distribution can be improved by increasing the number of series or stages of hammers. It is preferred that the main shaft is provided with at least five series or stages of hammers. For reasons of economy and practicality, this number preferably does not exceed twelve.

The number of hammers in each series or stage is at least two, preferably at least three. In practice, not more than six hammers will be used in each stage.

The pieces of fiber impregnated with a resin matrix, which are also known as “prepregs,” are preferably smaller than about 20× about 20 cm (and, more preferably, smaller than about 10× about 10 cm) when they are introduced into the mill, because larger pieces may damage the internals of the mill. Cutting is, of course, one way of reducing the size of large pieces, but crushing is preferred because it causes a certain degree of delamination of the fibers and the matrix.

At least in the series or stages farthest from the inlet of the hammer mill, the distance between the hammers and the sieve is preferably between about 2 and about 30 mm, and more preferably between about 4 and about 10 mm. In another embodiment of the invention, the distance between the hammers and the sieve, at least in the series or stages farthest from the inlet of the hammer mill, is between about 3 and about 30 mm, and more preferably, between about 5 and about 10 mm.

The mesh size of the sieve, which plays an important part in the degree of separation and the size of the resin particles, is preferably between about 3 and about 20 mm, more preferably between about 5 and about 10 mm.

If the total area of the holes in the sieve is large, the production capacity of the mill will be high. It is preferred that the ratio of the total area of the holes in the sieve to the total area of the sieve is in the range from about 30 to about 60%, and preferably in the range from about 40 to about 50%. Within this range a high capacity is combined with sufficient mechanical strength of the sieve.

Other parameters which play a significant role in the production capacity and the degree of separation are the number of revolutions per minute of the shaft (preferably in excess of 700 RPM) and the shape of the hammer.

With the process according to this invention, it is possible to obtain fibrous material in which the content of resin in the resulting fiber fraction is lower than about 3%.

The invention further pertains to a composite material comprising high-tenacity fibers obtained with the separation process described above, which materials are inexpensive and contribute substantially to a reduction of pollution. Examples of such materials are friction papers in clutches, clutch faces, gaskets, and brake shoes, pads, and linings.

The resin should be brittle or friable to a certain extent. Examples of suitable and common resins are epoxy resin, phenolic resins, and cross-linked polyesters. In most anti-ballistic articles such as helmets, the resin will normally be present in an amount below 25 wt %, for example 12-13 wt %. The recovered resin also can be re-used, e.g., in brake linings.

The fibers can be in the form of staple fibers, (unidirectional) filaments, a non-woven or, preferably, a fabric. Examples of high-tenacity fibers which can be regained with the process according to the invention are aramid fibers, especially PPDT fibers and extended chain polyethylene fibers. In general, fibers which are not pulverized by the action of the hammer mill can be regained by the process according to this invention.

While this invention has been described in conjunction with the specific embodiments above, it is evident that many alternatives, combinations, modifications and variations are apparent to those skilled in the art. Accordingly, the preferred embodiments of this invention, as set forth above, are intended to be illustrative and not limiting. Various charges can be made without departing from the spirit and scope of this invention.

What is claimed is:

1. A process for recycling a material containing high-tenacity fibers impregnated with a resin matrix, comprising:
introducing a material containing high-tenacity fibers and a resin matrix into a hammer mill comprising a shaft mounted with at least three stages of hammers and a substantially cylindrical sieve disposed substantially concentrically around the shaft;
milling the material for a time sufficient to grind at least about 50% of the resin into small particles; and
separating the small resin particles from the high-tenacity fibers using the sieve.

2. The process according to claim 1, wherein the material is milled for a time sufficient to grind at least about 80% of the resin into small particles.

3. The process according to claim 1, wherein the shaft and the sieve are disposed substantially vertically.

4. The process according to claim 1, wherein at least a stage of the hammers nearest to the inlet of the hammer mill are pivotably and resiliently mounted on the shaft.

5. The process according to claim 1, wherein the shaft is mounted with at least five stages of hammers.

6. The process according to claim 1, wherein the number of hammers in each stage of hammers is at least three.

7. The process according to claim 1, wherein at least in a stage of the hammers farthest from the inlet of the hammer mill, the distance between the hammers and the sieve is between about 2 mm and about 30 mm.

8. The process according to claim 1, wherein at least in a stage of the hammers farthest from the inlet of the hammer mill, the distance between the hammers and the sieve is between about 4 mm and about 10 mm.

9. The process according to claim 1, wherein the mesh size of the sieve is between about 3 mm and about 20 mm.

10. The process according to claim 1, wherein the mesh size of the sieve is between about 5 mm and about 10 mm.

11. The process according to claim 1, wherein the content of resin in a resulting fiber fraction is lower than about 3%.

12. A composite material comprising high-tenacity fibers obtained by the process of claim 1.

13. The composite material according to claim 12, wherein the fibers are comprised of aramid.
